(19) United States
(12) Patent Application Publication
(10) Pub. No.: US 2009/0248474 A1
(43) Pub. Date: Oct. 1, 2009

(54) MEETING PLANNING ASSISTANCE VIA NETWORK MESSAGES

(76) Inventors: Eric Philip Fried, Austin, TX (US); Rajeev Mishra, Bangalore (IN); Konagalli Narasimhaiah Rajesh, Bangalore (IN); Suresh Sabarathinam, Bangalore (IN)

Correspondence Address: IBM Corp. (AUS/RCR);c/o The Rolnik Law Firm, P.C., 24 N. Main St., Kingwood, TX, 77339, US

(21) Appl. No.: 12/060,410

(22) Filed: Apr. 1, 2008

(51) Int. Cl. G06Q 10/00

(52) U.S. Cl. 705/8

(57) ABSTRACT

The present invention provides a computer implemented method and apparatus to invite people by an email system to meetings or events through a scheduling server of a data processing machine. The scheduling server receives a plurality of invitees, where each invitee's vote has weight in the probability of scheduling a meeting at the desired time. The plurality of vote weights is heterogeneous. The scheduling server receives a meeting duration, a meeting option begin-time, and a meeting option end-time. The scheduling server excludes committed time of each invitee between the at least one meeting option begin-time and the at least one meeting option end-time to form a set of meeting times that are divided into a manageable set of meeting options. The scheduling server presents the manageable set of options to each invitee. The scheduling server receives votes from a voting invitee to form collected votes. Each vote is weighted based on the vote weight of the voting invitee. The scheduling server determines a leading option based on the collected votes and commits the leading option as the scheduled time for the meeting.

### BACKGROUND OF THE INVENTION

1. Field of the Invention

The present invention relates generally to a computer implemented method, data processing system, and computer program product for coordinating schedules. More specifically, the present invention relates to collecting bids or votes to select a meeting time.

2. Description of the Related Art

Modern uses of networked computers permit coordinating of multiple persons' schedules by allowing users to share calendars to show times that are free and times already committed for each user. Accordingly, a meeting planner can see what times users can agree on without the excuse those times are already logged as committed within a server.

However, such systems fail to provide a feature for users who are targeted for invitations, to indicate a preference for one time over another. For example, some people are “morning people” and are better able to grasp and retain meeting details if the meeting is held in the morning. If given a choice between a morning meeting and afternoon meeting, such people would tend to select the meeting choice given for the morning. There are many reasons why someone might prefer one time as opposed to another. Reasons of personal productivity vary between members of an organization. Accordingly, it would be helpful if users could cast votes or otherwise feedback to a meeting planner their preferences for meetings.

### SUMMARY OF THE INVENTION

The present invention provides a computer implemented method and apparatus to invite people by an email system to meetings or events through a scheduling server of a data processing machine. The scheduling server receives a plurality of invitees, where each invitee's vote has weight in the probability of scheduling a meeting at the desired time. The plurality of vote weights is heterogeneous. The scheduling server receives a meeting duration, a meeting option begin-time, and a meeting option end-time. The scheduling server excludes committed time of each invitee between the at least one meeting option begin-time and the at least one meeting option end-time to form a set of meeting times that are divided into a manageable set of meeting options. The scheduling server presents the manageable set of options to each invitee. The scheduling server receives votes from a voting invitee to form collected votes. Each vote is weighted based on the vote weight of the voting invitee. The scheduling server determines a leading option based on the collected votes and commits the leading option as the scheduled time for the meeting.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a data processing system in accordance with an illustrative embodiment of the invention;

FIG. 2 is a network of computers in accordance with an illustrative embodiment of the invention;

FIGS. 3A and 3B are a user interface for composing meeting election invitations and responding to meeting election invitations, respectively, in accordance with an illustrative embodiment of the invention;

FIG. 4A is a set of some employee records in accordance with an illustrative embodiment of the invention;

FIG. 4B is committed time records for an employee in accordance with an illustrative embodiment of the invention;

FIG. 4C is a set of holidays for a country in accordance with an illustrative embodiment of the invention;

FIG. 5 is a flowchart of steps to change employee status in accordance with an illustrative embodiment of the invention;

FIG. 6 is a flowchart to present meeting options in accordance with an illustrative embodiment of the invention; and

FIG. 7 is an example of narrowing periods to a manageable set of options in accordance with an illustrative embodiment of the invention.

### DETAILED DESCRIPTION OF THE PREFERRED EMBODIMENT

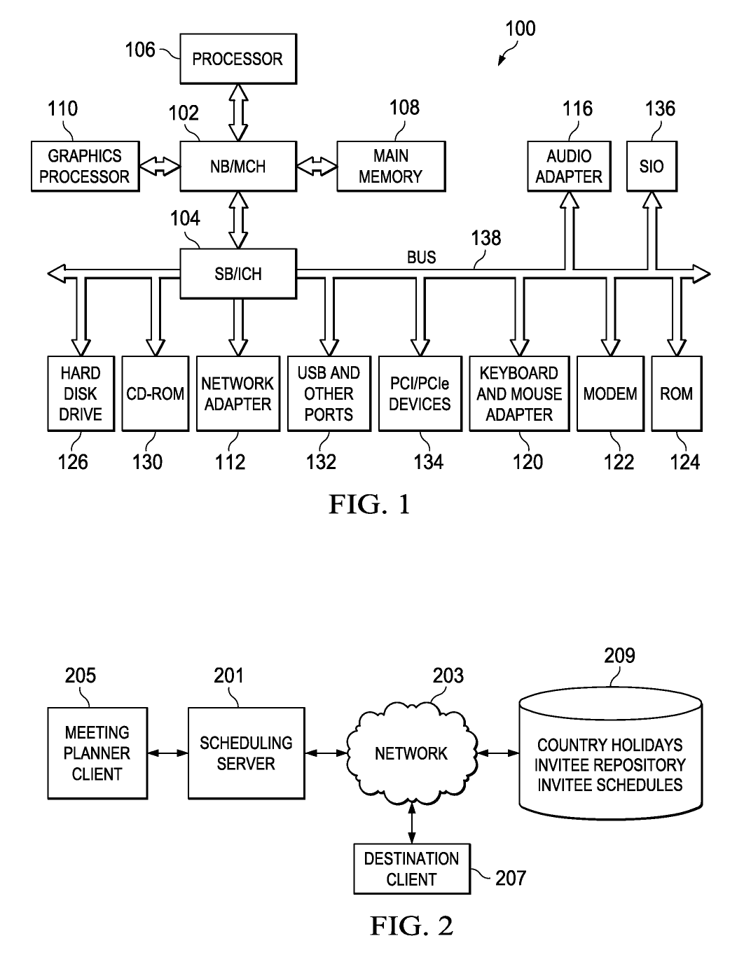

With reference now to the figures and in particular with reference to FIG. 1, a block diagram of a data processing system is shown in which aspects of an illustrative embodiment may be implemented. Data processing system 100 is an example of a computer, in which code or instructions implementing the processes of the present invention may be located. In the depicted example, data processing system 100 employs a hub architecture including a north bridge and memory controller hub (NB/MCH) 102 and a south bridge and input/output (I/O) controller hub (SB/ICH) 104. Processor 106, main memory 108, and graphics processor 110 connect to north bridge and memory controller hub 102. Graphics processor 110 may connect to the NB/MCH through an accelerated graphics port (AGP), for example.

In the depicted example, local area network (LAN) adapter 112 connects to south bridge and I/O controller hub 104 and audio adapter 116, keyboard and mouse adapter 120, modem 122, read only memory (ROM) 124, hard disk drive (HDD) 126, CD-ROM drive 130, universal serial bus (USB) ports and other communications ports 132, and PCI/PCIe devices 134 connect to south bridge and I/O controller hub 104 through bus 138 and bus 140. PCI/PCIe devices may include, for example, Ethernet adapters, add-in cards, and PC cards for notebook computers. PCI uses a card bus controller, while PCIe does not. ROM 124 may be, for example, a flash binary input/output system (BIOS). Hard disk drive 126 and CD-ROM drive 130 may use, for example, an integrated drive electronics (IDE) or serial advanced technology attachment (SATA) interface. A super I/O (SIO) device 136 may be connected to south bridge and I/O controller hub 104.

An operating system runs on processor 106 and coordinates and provides control of various components within data processing system 100 in FIG. 1. The operating system may be a commercially available operating system such as Microsoft® Windows® XP. Microsoft and Windows are trademarks of Microsoft Corporation in the United States, other countries, or both. An object oriented programming system, such as the Java™ programming system, may run in conjunction with the operating system and provides calls to the operating system from Java™ programs or applications executing on data processing system 100. Java™ is a trademark of Sun Microsystems, Inc. in the United States, other countries, or both.

Instructions for the operating system, the object-oriented programming system, and applications or programs are located on storage devices, such as hard disk drive 126, and may be loaded into main memory 108 for execution by processor 106. The processes of the present invention can be performed by processor 106 using computer implemented instructions, which may be located in a memory such as, for example, main memory 108, read only memory 124, or in one or more peripheral devices.

Those of ordinary skill in the art will appreciate that the hardware in FIG. 1 may vary depending on the implementation. Other internal hardware or peripheral devices, such as flash memory, equivalent non-volatile memory, and the like, may be used in addition to or in place of the hardware depicted in FIG. 1. In addition, the processes of the illustrative embodiments may be applied to a multiprocessor data processing system.

In some illustrative examples, data processing system 100 may be a personal digital assistant (PDA), which is configured with flash memory to provide non-volatile memory for storing operating system files and/or user-generated data. A bus system may be comprised of one or more buses, such as a system bus, an I/O bus and a PCI bus. Of course, the bus system may be implemented using any type of communications fabric or architecture that provides for a transfer of data between different components or devices attached to the fabric or architecture. A communication unit may include one or more devices used to transmit and receive data, such as a modem or a network adapter. A memory may be, for example, main memory 108 or a cache such as found in north bridge and memory controller hub 102. A processing unit may include one or more processors or CPUs. The depicted example in FIG. 1 is not meant to imply architectural limitations. For example, data processing system 100 also may be a tablet computer, laptop computer, or telephone device in addition to taking the form of a PDA.

The terminology used herein is for the purpose of describing particular embodiments only and is not intended to be limiting of the invention. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module”, or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The aspects of the illustrative embodiments provide a computer implemented method, data processing system, and computer program product for setting meeting options, collecting feedback on those meeting options, and weighting such feedback to reach a consensus decision concerning a time for the meeting to be held.

FIG. 2 is a network of computers in accordance with an illustrative embodiment of the invention. Initially, meeting planner client 205 is a source for a message sent to a scheduling server 201. The scheduling server may query repository 209 via network 203. Repository 209 may be a file system, database, or other storage facility that keeps data concerning country holidays, invitee records, and invitee schedules. Such information may be used to determine times suitable for multiple invitees to gather or otherwise attend a meeting. An invitee is a user account having a login identifier of a user. When used in the context of a user that has logged into his user account, the invitee is the user himself or any other person that is logged in and using the user account. When used in the context of an invitation or initial communications generated to initiate an invitation, the invitee is one or more user accounts that are invited to a meeting. Once such preliminary details are available, scheduling server 201 may transmit options to and collect responses from at least one destination client 207. A destination client may provide a user interface by which an invitee is authenticated. In addition, an invitee may communicate information concerning her schedule through a destination client.

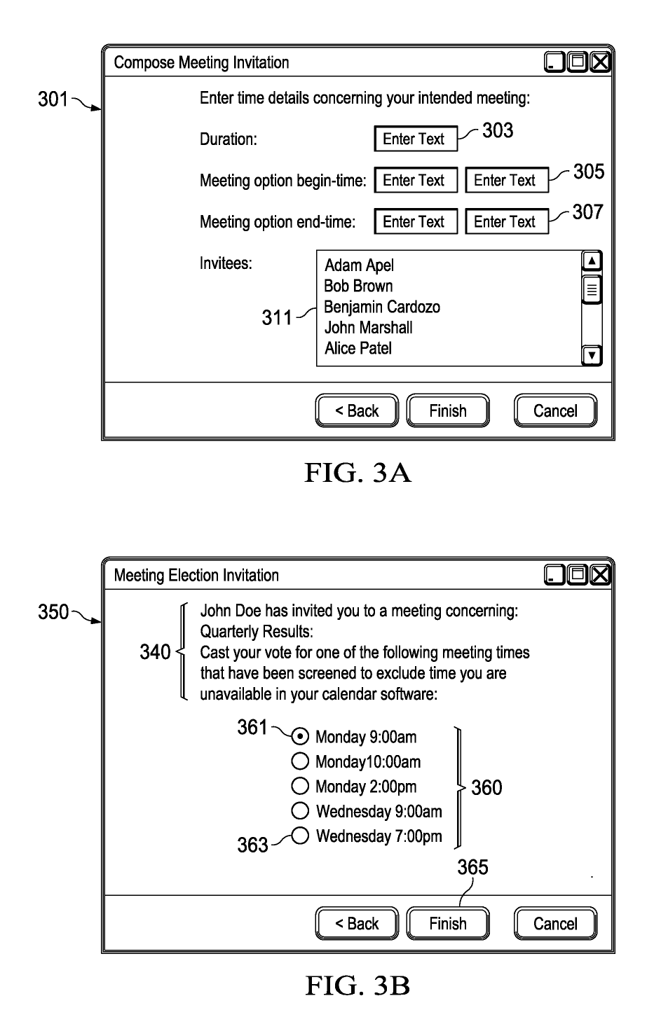

FIGS. 3A and 3B are a user interface for composing meeting election invitations and responding to meeting election invitations, respectively, in accordance with an illustrative embodiment of the invention. In FIG. 3A, a meeting planner may enter details concerning compose meeting invitation dialog 301. The invitation dialog is presented, for example, on meeting planner client 205 of FIG. 2. Accordingly, a meeting planner may enter a duration, a meeting option begin-time, and a meeting option end-time to duration field 303, meeting option begin-time field 305, and meeting option end-time field 307, respectively. A meeting duration is a period set by a meeting planner. A meeting option begin-time is an earliest time set by a meeting planner for a meeting. The earliest time may be an initial criterion for setting manageable set of options. A meeting option end-time is a latest time set by a meeting planner for a meeting.

In addition, compose meeting invitation dialog 301 provides an invitee field 311. A user may enter an invitee identifier to select one or more invitees to a meeting. Invitee identifier is an identifier assigned to a user. The invitee identifier can be a login identifier. An invitee identifier may be, for example, an invitee name, an email address, or other convenient key used to look-up invitee information within a repository such as, for example, repository 209 of FIG. 2.

Following some processing of fields entered in the invitation dialog, a scheduling server may transmit details shown in a meeting election invitation on a destination client. A meeting election invitation dialog may be a feature integrated into an email client, a browser, or an instant messenger client, among others.

FIG. 3B includes meeting election invitation dialog 350. Specifics of the meeting may be mentioned in meeting specifics section 340. Specifics are details that alert a user as to the subject matter of the meeting. Specifics can include, for example, the name of the meeting planner, an agenda, names of any presenters, among other details. The meeting election invitation includes several meeting options. A meeting option is a proposed meeting begin-time matched to a proposed meeting end-time or a limited set of periods sufficiently long to accommodate a meeting duration. The meeting begin-time and meeting end-times are ‘proposed’ since such times have not yet been agreed upon. A meeting option is the pair of these two times, and may be expressed within a dialog box as shown here, within a data record, or within a message.

Meeting options 360 can be shown in chronological order. In addition, proposed meeting end-times may be implicit in situations where the duration of the meeting is stated in the specifics section. Meeting election invitation dialog 350 may adjust times to reflect a user's preferred time zone, cultural format, among others. Each meeting option may be presented in the dialog with a user-selectable radio-button. Meeting options 360 may include first meeting option 361 and last meeting option 363. In addition, a submit button may be provided for a user to complete voting. A submit button may be finish button 365, for example. In addition to the dialog pictured in FIG. 3B, it is appreciated that an alternate embodiment may feature a button paired with a distinct meeting option. In such a dialog, each button records a user's vote and triggers submission of the user's intention to a meeting server.

The dialog may be indirectly controlled by a scheduling server to present a manageable set of meeting options. A manageable set of meeting options is a threshold set by a system administrator to limit the number of choices to permit rapid assimilation of options and choice for options presented below the threshold as compared to options greater than the threshold. Such a threshold can be set based on a recognition that providing a large number of choices, for example, 50, can delay a choice for the reason that reading the choices can take more time for each invitee as compared to reading fewer choices, for example, five. A suitable range for setting a threshold may be between 2 and 10.

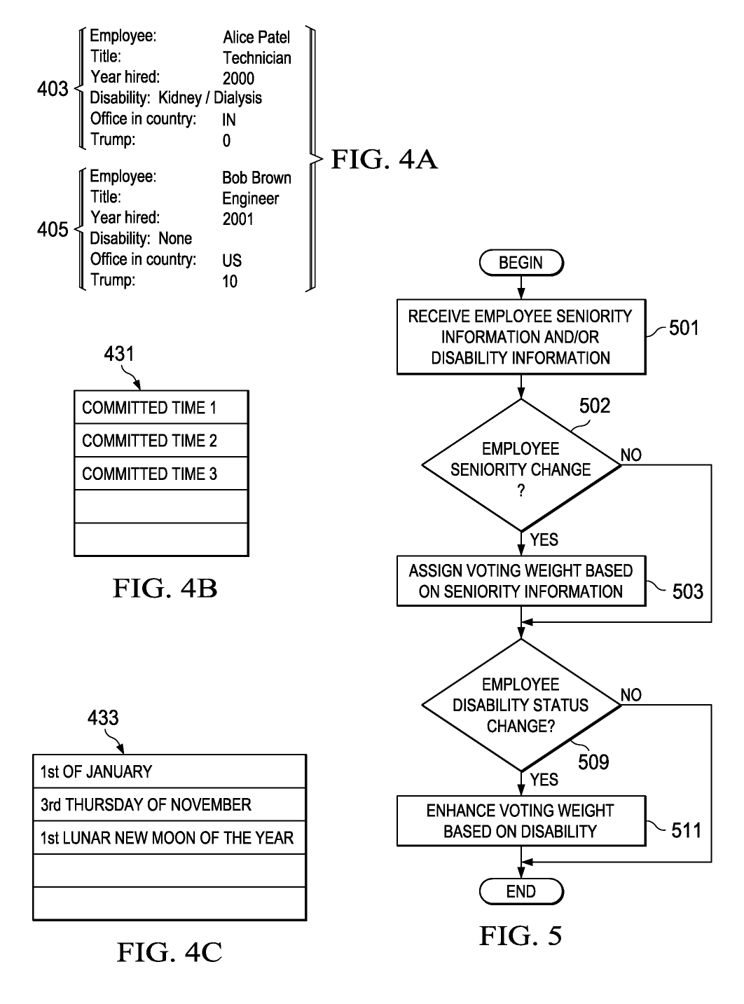

FIG. 4A is a set of some employee records in accordance with an illustrative embodiment of the invention. Employee records may be used to establish a basis for weighting an employee's votes given through a meeting election invitation dialog, called a vote weight. Weighting of an employee's votes is established with a vote weight. A vote weight is a number assigned to an invitee based on seniority. Seniority can be based on years employed, age, years of education, salary among other things. Example employee records include “Alice Patel” 403, and “Bob Brown” 405. Such records may be stored to an invitee repository. An invitee repository is a repository having one or more scheduling records of the invitees of an invitation. It is appreciated that alternate organizations may exist within which people are called to meetings. Such organizations can include schools comprised of students, clubs comprised of members, musical groups comprised of musicians, among others. As such, each student, member, musician, etc. may be among persons tracked within an invitee repository.

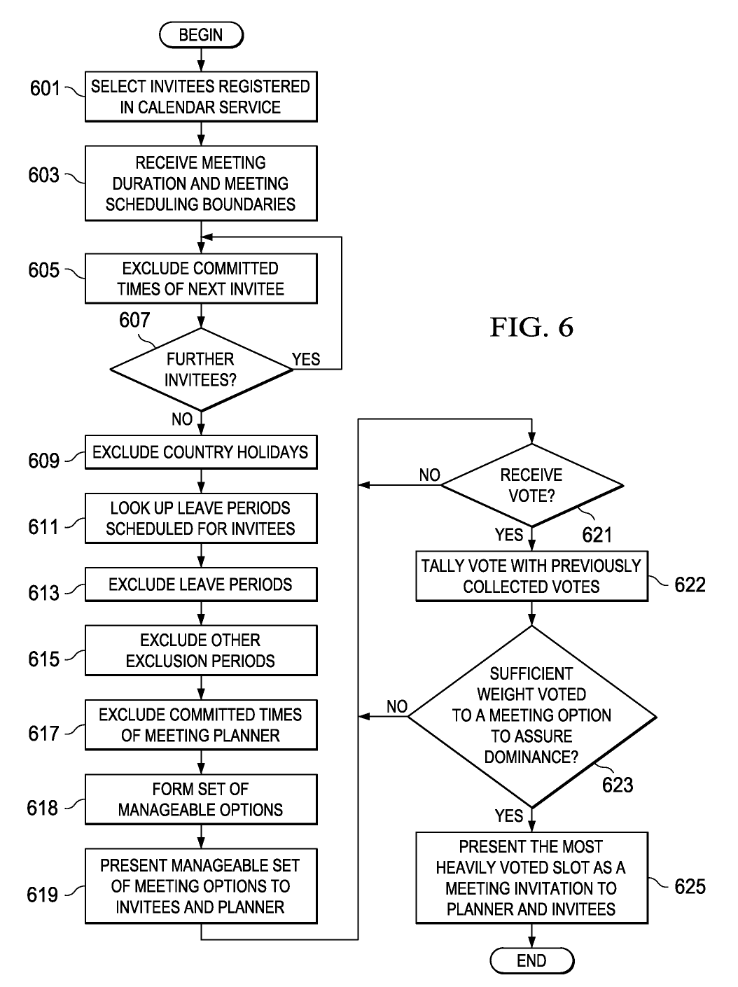

An employee record may contain the following information: the employee's name, title, year hired, and the country in which that employee has an office. In addition, aspects that may enhance an invitee's vote may also be recorded to the employee record. Such aspect may include, for example, the existence and nature of a disability, and the availability of a trump vote weight, explained further with reference to FIG. 6 below.

FIG. 4B is committed time records for an employee in accordance with an illustrative embodiment of the invention. A committed time may comprise a beginning time and an ending time. Committed time 1431 is one among several times that may apply to an employee or other user. A user may enter such times or otherwise approve such times by using a client in cooperation with a repository as well as other data processing systems.

FIG. 4C is a set of holidays for a country in accordance with an illustrative embodiment of the invention. Each holiday record may comprise a date, and optionally a name for a holiday. Alternatively, each holiday may comprise a rule that describes a calculation to perform to determine a holiday for a given period. For example, holiday record 433 includes a rule that describes January 1 as an annual holiday.

FIG. 5 is a flowchart of steps to change employee status in accordance with an illustrative embodiment of the invention. Each step of FIG. 5 may be performed by a scheduling server with support from a repository. The steps performed in FIG. 5 may permit the scheduling server or other data processing system to set or change a vote weight associated with an invitee, such as an employee. Initially, the scheduling server may receive an employee seniority information and/or disability information (step 501). Next, the scheduling server determines if the employee seniority has changed (step 502). The scheduling server may treat a newly added employee as a change to seniority. A positive determination at step 502 causes the scheduling server to assign a voting weight to an employee based on seniority information (step 503).

For example, in adding employees shown in FIG. 4A, Alice Patel, a year 2000 hire, may be assigned a voting weight of 0, while Bob Brown, a year 2001 hire, may be assigned a voting weight of five during the operation of step 502 and 503. A voting weight may be set in a record of the employee, for example, by adding a field for voting weight to each employee record of FIG. 4A. The scheduling server next determines whether the employee's disability status has changed (step 509). If the employee's disability status has changed, the scheduling server may enhance the voting weight of the employee based on disability. For example, Alice Patel may require dialysis in connection with a disability. Accordingly, the scheduling server, at step 511, may add 10 to a non-disabled, voting weight. Such an arrangement may allow a disabled person of low seniority to have a vote that outweighs a non-disabled person of relatively higher seniority. A disability status is an entry to an invitee record that indicates that the invitee has a disability. The disability status may be entered by a user based on the user's personal experiences and culture, as well as the amount of personal information provided by the subject invitee. As a result, the disability status may reflect the judgment of the user who enters such information. Processing terminates thereafter.

A negative outcome to step 502 directs the scheduling server to step 509. If the employee's disability status has changed then the scheduling server enhances the voting weight based on disability (step 511). Processing terminates thereafter. In addition, a negative outcome to step 509 also may cause processing to terminate.

FIG. 6 is a flowchart to present meeting options in accordance with an illustrative embodiment of the invention. Initially, a scheduling server may receive a set of invitees. Thus, a scheduling server may select invitees registered in a calendar service (step 601). A calendar service is any application that maintains a repository concerning committed time of a user or subscriber to the calendar service. Committed time is time indicated in one or more scheduling records of an invitee that correspond to the invitee being expected to be unavailable.

Next, the scheduling server may receive a meeting duration and meeting scheduling boundaries (step 603). The meeting scheduling boundaries include a meeting option begin-time, and meeting option end-time. Next, the scheduling server may iterate through a list of invitees provided by a planner client. Iterating through a list of invitees may include repeatedly executing steps 605 and 607 explained below. The scheduling server excludes any committed times of a next invitee (step 605). The scheduling server may determine committed times for each invitee by obtaining scheduling records from an employee repository. A scheduling record is a data structure having one or more time periods associated with an invitee such that the period denotes time the invitee is unavailable. Next, the scheduling server determines if there are further invitees (step 607). If there are further invitees, the scheduling server repeats step 605 for at least one such further invitee.

If all invitees have been processed for committed time, as indicated by a negative outcome to step 607, the scheduling server excludes country holidays (step 609). A country holiday is a holiday, or other routinely observed day off according to the norms and customs of a country. A set of country holidays is formed to reflect countries where all invitees are based. The scheduling server may eliminate time associated with holidays based on any country of any invitee.

Next, the scheduling server may lookup leave periods scheduled for each invitee (step 611). Accordingly, the scheduling server excludes all leave periods (step 613). Scheduled leave is leave that makes an invitee unavailable for extended periods of time, for example, vacation, convalescence, sabbatical, among others. The scheduling server may also exclude other exclusion periods (step 615). Such periods may be periods established for a company picnic or other social activity of the aggregate of all members that subscribe to the calendaring service. Next, the scheduling server may exclude committed times of the meeting planner (step 617). The outcome of step 617 is a set of meeting options. The set of meeting options can be defined by all open time remaining following step 617 that is sufficiently long to accommodate the meeting duration. The number of meeting options may be limited by the granularity that a scheduling server can allocate beginning times through one or more ranges of possible beginning times.

Next, the scheduling server may form a set of manageable options (step 618). The manageable set of options may depend, at least in part, on a threshold established by a system administrator.

An example can illustrate how manageable options may be extracted from a tract of time. In this example, a one-hour meeting is requested, and through the previous steps of FIG. 6, a two-hour block beginning at 1 pm and ending at 3 pm is open for all invitees and the meeting planner. Accordingly, the scheduling server may divide the available start times of 1 pm through 2 pm to four equally spaced times: 1:00 pm; 1:20 pm; 1:40 pm and 2:00 pm.

In a second example, a granularity factor may also be applied which forms a rule that no meeting option may begin within 10 minutes of another meeting option. Accordingly, in an event of a one hour meeting requested with open times fitting between 1 pm and 2 pm, a manageable set of meeting options threshold of 10 can be applied. Consequently, the operation of step 618 may produce 7 meeting options that are each 10 minutes apart from each other. Although a meeting granularity factor of 10 minutes is given in the above example, a meeting granularity factor of one hour may provide adequate options for invitees to agree.

Next, the scheduling server may present the manageable set of meeting options to the invitees and the meeting planner (step 619). Presenting the manageable set of meeting options to the invitees may comprise transmitting an email or other electronic message to each invitee. Such an email may include the full contents of the manageable set of meeting options, or include a link to an online resource from which a destination client may access such manageable set of meeting options. Consequently, each user may be presented with a meeting election invitation, for example, meeting election invitation dialog 350 of FIG. 3B.

Next, the scheduling server determines if it has received a vote from a voting invitee (step 621). A voting invitee is an invitee that has transmitted a valid vote in accordance with a user interface used to collect votes. A vote is a message formed according to parameters of a “manageable set of meeting options” based on an invitee input. The vote can include an identifier of the invitee and a serial number that identifies the meeting request to which the vote applies. The vote may be received by any one of several means. For example, the scheduling server may receive the vote by email, HTTP, secure shell, or any other convenient manner. Such a vote may be with our without user authentication. The scheduling server may repeatedly check for votes during times that a vote is not yet received.

A negative determination to step 621 causes the scheduling server to cycle back around and begin step 621 again. This process continues until a vote is received.

A positive determination to step 621, causes the scheduling server to tally the vote with any previously collected vote associated with the invitation (step 622). Collected votes are at least two votes tallied to a data structure called “current vote status”. A current vote status data structure stores a sum of all vote weights collected for each meeting option of a meeting request.

In connection with tallying the vote, the scheduling server may establish a leading option for the meeting request. The leading option is the meeting option among the manageable set of options that has the largest vote among all meeting options of the meeting request. Next, the scheduling server may determine if there is sufficient weight voted to a meeting option to assure dominance of that meeting option (step 623). Dominance occurs when the uncollected vote weights added to the next largest leading option is less than the vote weight associated with the leading option. Under such circumstances, the remaining candidate meeting options are mathematically excluded from obtaining sufficient vote weight to exceed the leading option. Accordingly, further voting would be useless. When the scheduling server positively determines step 623, the scheduling server can present the most heavily voted slot, or leading option, as a meeting invitation to the planner and invitees (step 625). A meeting invitation is message sent to an invitee concerning one meeting begin-time associated with a meeting request. The meeting request may be a similar meeting request as shown formed by the operation of steps 601 and 603 above. Processing terminates thereafter.

However, a negative determination to step 623 causes the scheduling server to continue to determine if votes are received at step 621. The process continues as described previously with a positive result in steps 622 and 623, resulting in termination after step 625.

The flowchart of FIG. 6 may operate in a modified manner when an invitee casts a trump vote. A trump vote is any vote that is modified by a trump value. The trump weight value is the sum of the vote weight with the trump value. A trump vote can be assigned a user temporarily or permanently. For example, an invitee may be on a business trip to the site of the meeting during at least some portion of time between meeting scheduling boundaries. Accordingly, to enhance the probability that the invitee can be physically present rather than being telephonically present, that invitee may be provided with a trump value in his employee records. Many other circumstances may warrant providing an extra boost to a voting invitee. As a result, of an invitee having a trump value assigned within his employee record, steps 622, 623 and 625 may be modified to use trump weight values in place of vote weights. Thus, when determining the leading option, the scheduling server may determine the leading option based at least in part on the trump vote.

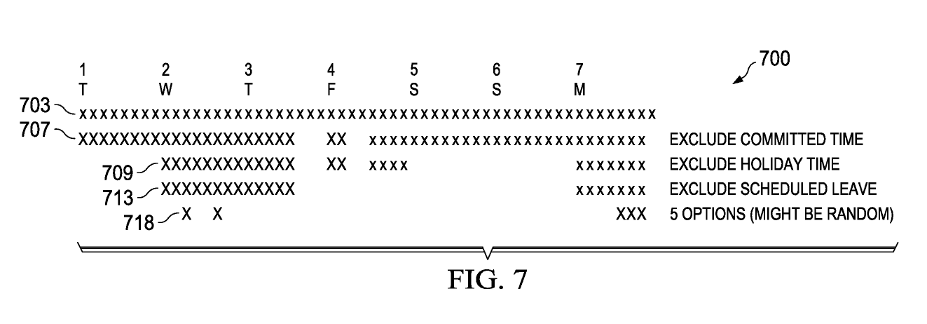

FIG. 7 is an example of narrowing periods to a manageable set of options in accordance with an illustrative embodiment of the invention. Table 700 of screened times denotes each block of available time as free or uncommitted with an ‘X’, such that each row represents either an intermediate stage of the processing or an end point to processing in FIG. 6. Initially, a meeting planner may provide meeting option begin-time, and meeting option end-time of January 1, 12:00 am, and January 8, 12:00 am. Such times are meeting scheduling boundaries for initial period 703. Next, the scheduling server performs steps through and including 607 of FIG. 6 to exclude committed times. The available times are period less committed time 707. Next, the scheduled server performs steps through and including 609 of FIG. 6. The available times are period less committed time and holiday time 709. Next, the scheduling server performs steps through and including 613. Available times become period less committed time, less holiday time, less scheduled leave 713. A final set of steps through and including step 618 may produce a manageable set of meeting options 718.

The illustrative embodiments permit a user to collect bids or votes to select a meeting time. The illustrative embodiments may enable a quick and more efficient way to coordinate multiple invitees' schedules by allowing users to share calendars to show times that are free and times that are already committed for each user. Accordingly, a meeting planner can see what times users can agree on, and schedule the meeting letting an automatic system accord weights and trump votes according to the attributes of each invitee.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for inviting people to meetings, the method comprising:
receiving a plurality of invitees, each invitee having a vote weight, wherein a plurality of vote weights including each invitee's vote weight is heterogeneous;
receiving a meeting duration, an at least one meeting option begin-time, and an at least one meeting option end-time;
excluding committed time of each invitee between the at least one meeting option begin-time and the at least one meeting option end-time to form a set of meeting options, wherein the committed time is from an invitee repository;
dividing the set of meeting options into a manageable set of meeting options;
presenting the manageable set of meeting options to each invitee;
receiving votes from a voting invitee to form collected votes, wherein each vote is weighted based on the vote weight of the voting invitee;
determining a leading option based on the collected votes; and
committing a leading option as a committed time for at least one invitee the meeting.

2. The computer implemented method of claim 1, further comprising:
transmitting at least one meeting invitation to at least one invitee based on the leading option, and the vote weights are assigned based on at least one selected from a group consisting of seniority of each invitee, and disability status of each invitee.

3. The computer implemented method of claim 1, wherein the step of excluding further comprises:
excluding a scheduled leave of each invitee from the set of meeting options based on the scheduled leave of each invitee.

4. The computer implemented method of claim 1, wherein the step of excluding further comprises:
forming a set of country holidays based on a set of countries associated with the plurality of invitees; and
excluding the set of country holidays from the set of meeting options.

5. The computer implemented method of claim 4, wherein the step of dividing the set of meeting options into a manageable set of meeting options comprises creating meeting options having meeting option begin-times that are separated by at least one hour.

6. The computer implemented method of claim 1, further comprising:
receiving a trump vote as a collected vote; and
determining the leading option based on the trump vote, wherein the step of committing is in response to determining the leading option based on the trump vote.

7. The computer implemented method of claim 1, wherein the step of presenting the manageable set of options to each invitee further comprises presenting the leading option, and the steps of presenting the manageable set of options, collecting, and determining are repeated.

8. A computer program product for inviting people to meetings, the computer program product comprising:
computer usable program code configured to receive a plurality of invitees, each invitee having a vote weight, wherein a plurality of vote weights including each invitee's vote weight is heterogeneous;
computer usable program code configured to receive a meeting duration, an at least one meeting option begin-time, and an at least one meeting option end-time;
computer usable program code configured to exclude committed time of each invitee between the at least one meeting option begin-time and the at least one meeting option end-time to form a set of meeting options, wherein the committed time is from an invitee repository;
computer usable program code configured to divide the set of meeting options into a manageable set of meeting options;
computer usable program code configured to present the manageable set of meeting options to each invitee;
computer usable program code configured to receive votes from a voting invitee to form collected votes, wherein each vote is weighted based on the vote weight of the voting invitee;
computer usable program code configured to determine a leading option based on the collected votes; and
computer usable program code configured to commit a leading option as a committed time for at least one invitee the meeting.

9. The computer program product of claim 8, further comprising:
computer usable program code configured to transmit at least one meeting invitation to at least one invitee based on the leading option, and the vote weights are assigned based on at least one selected from a group consisting of seniority of each invitee, and disability status of each invitee.

10. The computer program product of claim 8, wherein the computer usable program code configured to exclude further comprises:
computer usable program code configured to exclude a scheduled leave of each invitee from the set of meeting options based on the scheduled leave of each invitee.

11. The computer program product of claim 8, wherein the computer usable program code configured to exclude further comprises:
computer usable program code configured to form a set of country holidays based on a set of countries associated with the plurality of invitees; and
computer usable program code configured to exclude the set of country holidays from the set of meeting options.

12. The computer program product of claim 11, wherein the computer usable program code configured to divide the set of meeting options into a manageable set of meeting options comprises computer usable program code configured to create meeting options having meeting option begin-times that are separated by at least one hour.

13. The computer program product of claim 8, further comprising:
computer usable program code configured to receive a trump vote as a collected vote; and
computer usable program code configured to determine the leading option based on the trump vote, wherein the computer usable program code configured to commit is responsive to determining the leading option based on the trump vote.

14. The computer program product of claim 8, wherein the computer usable program code configured to present the manageable set of options to each invitee further comprises computer usable program code configured to present the leading option, and the computer usable program code configured to present the manageable set of options, collect, and determine is repeatable.

15. A data processing system comprising:
a bus;
a storage device connected to the bus, wherein computer usable code is located in the storage device;
a communication unit connected to the bus; and
a processing unit connected to the bus, wherein the processing unit executes the computer usable code for inviting people to meetings, wherein the processing unit executes the computer usable program code to receive a plurality of invitees, each invitee having a vote weight, wherein a plurality of vote weights including each invitee's vote weight is heterogeneous; receive a meeting duration, an at least one meeting option begin-time, and an at least one meeting option end-time; exclude committed time of each invitee between the at least one meeting option begin-time and the at least one meeting option end-time to form a set of meeting options, wherein the committed time is from an invitee repository; divide the set of meeting options into a manageable set of meeting options; present the manageable set of meeting options to each invitee; receive votes from a voting invitee to form collected votes, wherein each vote is weighted based on the vote weight of the voting invitee; determine a leading option based on the collected votes; and commit a leading option as a committed time for at least one invitee the meeting.

16. The data processing system of claim 15, wherein the processing unit further executes the computer usable code to transmit at least one meeting invitation to at least one invitee based on the leading option, and the vote weights are assigned based on at least one selected from a group consisting of seniority of each invitee, and disability status of each invitee.

17. The data processing system of claim 15, wherein in executing computer usable code to exclude, the processor executes computer usable code to exclude a scheduled leave of each invitee from the set of meeting options based on the scheduled leave of each invitee.

18. The data processing system of claim 15, wherein in executing computer usable code to exclude, the processor executes computer usable code to form a set of country holidays based on a set of countries associated with the plurality of invitees; and exclude the set of country holidays from the set of meeting options.

19. The data processing system of claim 18, wherein in executing computer usable code to divide the set of meeting options into a manageable set of meeting options, the processor executes computer usable code to create meeting options having meeting option begin-times that are separated by at least one hour.

20. The data processing system of claim 15, wherein the processing unit further executes the computer usable code to receive a trump vote as a collected vote; determine the leading option based on the trump vote, wherein the computer usable program code configured to commit is responsive to determining the leading option based on the trump vote.
